(19) United States
(12) Patent Application Publication
(10) Pub. No.: US 2019/0160852 A1
(43) Pub. Date: May 30, 2019

(54) KNOCK TYPE PEN

(71) Applicant: DONG-A PENCIL CO., LTD., Seoul (KR)

(72) Inventor: Hakjae Kim, Seoul (KR)

(21) Appl. No.: 15/857,227

(22) Filed: Dec. 28, 2017

(30) Foreign Application Priority Data
Nov. 24, 2017 (KR) 20-2017-0006032

(51) Int. Cl. B43K 24/04; B43K 24/08; B43K 7/12

(52) U.S. Cl. CPC B43K 24/04; B43K 7/12; B43K 24/084

(57) ABSTRACT

The present disclosure relates to a knock type pen including a housing in which a lead storing ink is received, a knock element which is placed moveably up and down in the housing, and has a button section protruding from an open upper side of the housing in an upper end part and a toothed protrusion coupled to a lower end part, and a rotary cam which is disposed between the lead and the knock element and rotatably placed in the housing, and has a guide protrusion which comes into contact with the toothed protrusion.

### CROSS-REFERENCE TO RELATED APPLICATION

This application claims priority of Korean Patent Application No. 20-2017-0006032, filed on Nov. 24, 2017, in the KIPO (Korean Intellectual Property Office), the disclosure of which is incorporated herein entirely by reference.

### BACKGROUND OF THE INVENTION

### Field of the Invention

The present disclosure relates to a knock type pen, and more particularly, to a knock type pen for preventing ink from leaking through the nib pushed out by a user's unintentional knock pressing and leaving stains on clothes or a bag.

### Description of the Related Art

In general, a pen can be classified into a fixed type pen in which the lead is fixed and the nib is exposed to the outside or concealed using an opening/closing cap, a rotary type pen in which as a part of the shaft rotates, the lead makes a linear movement and accordingly the nib is pushed in and out, a knock type pen in which when a part of the shaft is pressed, a spring moves to push the nib out, and a slide type pen in which the lead slides the nib to push the nib in and out.

Amon them, the knock type pen is convenient because of pushing the nib in and out in a simple manner through a motion of pressing a button section provided on the top of a housing.

This knock type pen is configured such that when the button section provided on the top of the housing is pressed once, the nib extends outside, turning into a writable state, and when the button section is pressed once again, the extended nib retracts into the housing, turning into a reception and protection state.

FIG. 1 is a diagram showing a conventional knock type pen, and FIG. 2 is an exploded view of a knock mechanism of the knock type pen of FIG. 1.

As shown in FIG. 1, the conventional knock type pen 10 is configured such that a lead 12 storing ink is received in a housing 11, and a knock body 15 which is manipulated moveably up and down is protrusively coupled to a slot (not shown) formed on the inner sidewall of the housing 11 in the upper part of the housing 11.

Furthermore, a rotary cam 16 is rotatably placed between the lead 12 and the knock body 15, and the knock body 15 and the rotary cam 16 form a knock mechanism 14 whereby the lead 12 is allowed to advance and draw back.

Moreover, a spring 21 is placed between the housing 11 and the lead 12 to apply an elastic force to the lead 12 in a direction in which the nib 13 retracts into the housing 11.

When a user presses a button section 17 protruding out of the housing 11 of the knock body 15, the lead 12 moves down and the nib 13 protruding at the end is pushed out of the housing 11.

In this instance, a guide protrusion 20 of the rotary cam 16 that comes into contact with a toothed protrusion 18 at the bottom of the knock body 15 slips out of the slot of the housing 11, and at the same time, slips out of one slope surface of the toothed protrusion 18 while rotating along the other slope surface, and the rotated guide protrusion 20 of the rotary cam 16 is stuck by a stopper step 19 protruding from the outer circumference of the knock body 15.

In this state, despite the elastic force of the spring 21 coupled to the nib 13, the lead 12 does not move up, so the nib 13 keeps being extended outside the housing 11.

When the nib 13 is extended outside, if the user presses the button section 17 again, the rotary cam 16 rotates by the method previously described so that the guide protrusion 20 of the rotary cam 16 is disposed between the stopper steps 19 of the knock body 15 and moves up by the elastic force of the spring 21 and thus the nib 13 retracts into the housing 21.

(a) in FIG. 3 is a diagram showing a shirt stained with ink due to ink leaks in the event that the button section of the knock type pen is pressed when the user puts the knock type pen on the shirt's pocket, (b) is an enlarged view of the contaminated part in (a), and FIG. 4 is a diagram showing a bag stained with ink due to ink leaks in the event that the button section of the knock type pen is pressed when the user puts the knock type pen in the bag.

The conventional knock type pen designed as above has a problem that when it is put on the user's clothes, for example, a pocket using a clip 22 provided on the side of the upper end of the housing 11 as shown in FIG. 3, or when it is put in a bag as shown in FIG. 4, the nib 13 is pushed out by the user's unintentional knock pressing, and ink leaks through the nib 13 extended outside, causing ink stains on the clothes or the bag.

In particular, recently, many knock type pens containing low viscosity ink to facilitate writing with a small force (pressure) are being offered. However, compared to high viscosity ink, low viscosity ink leaks in a higher amount from the nib due to the low viscosity, and when the nib is pushed out by an unintentional knock pressing as described above, larger ink stains leave on clothes or a bag because of better ability of absorption, resulting in more serious damage.

Korean Utility Model Publication No. 20-2016-0003130, published on Sep. 19, 2016, discloses a knock type pen.

### SUMMARY OF THE INVENTION

The present disclosure is designed to solve the problems such as the foregoing, and therefore the present disclosure is directed to providing a knock type pen for preventing ink from leaking through the nib pushed out by a user's unintentional knock pressing and leaving stains on clothes or a bag.

To achieve the objects, the present disclosure provides a knock type pen comprising a housing in which a lead storing ink is received, a knock element which is placed moveably up and down in the housing, and has a button section protruding from an open upper side of the housing in an upper end part and a toothed protrusion coupled to a lower end part, and a rotary cam which is disposed between the lead and the knock element and rotatably placed in the housing, and has a guide protrusion which comes into contact with the toothed protrusion, wherein a stopper protrusion is protrusively formed in a direction perpendicular to a lengthwise direction of the knock element on an outer circumferential surface of the knock element, and the housing has a guide hole formed therethrough along a lengthwise direction of the housing to guide the knock element with the stopper protrusion inserted into the guide hole when the knock element moves up, and a stopper hole formed therethrough extending in parallel or at a downward slant in an outer circumferential direction of the housing from an upper end of the guide hole to limit an upward movement of the knock element with the stopper protrusion inserted into the stopper hole.

Additionally, preferably, the stopper protrusion is in cylindrical shape, the guide hole and the stopper hole are in elliptical shape to conform to the stopper protrusion, and a protruding end of the stopper protrusion is exposed to outside of the guide hole and the stopper hole.

Moreover, preferably, the housing includes an upper housing having the guide hole and the stopper hole to move the knock element up and down, and a lower housing in which the lead and the rotary cam are received, and the upper housing and the lower housing are formed attachably and detachably.

The present disclosure has the following effect by the above problem-solving means.

The stopper protrusion is formed on the outer circumferential surface of the knock element, and the housing has the guide hole and the stopper hole into which the stopper protrusion is inserted, thereby preventing ink from leaking through the nib pushed out by the user's unintentional knock pressing and leaving stains on clothes or a bag.

In particular, in the case of use from low viscosity ink (300-3,000 cps) having relatively low viscosity to high viscosity ink (10,000-25,000 cps) having high viscosity, it can prevent ink from leaking out of the nib due to a knock pressing and leaving stains on clothes or a bag, and it can be applied to all writing instruments such as ballpoint pens employing low viscosity ink and high viscosity ink.

Moreover, the housing is divided into the upper housing and the lower housing which are coupled attachably and detachably, making it convenient to replace internal components and maintain and repair them.

Additionally, the end of the stopper protrusion formed in cylindrical shape is exposed to the outside of the guide hole and the stopper hole, allowing the user to easily manipulate.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a diagram showing the conventional knock type pen.

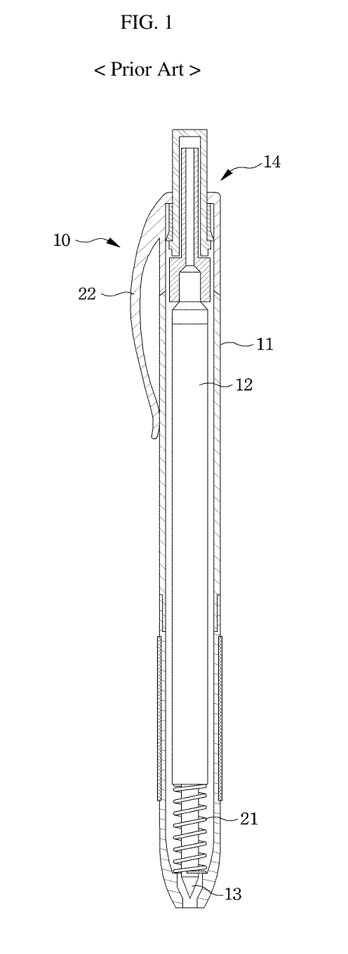

FIG. 2 is an exploded view of a knock mechanism of the knock type pen of FIG. 1.

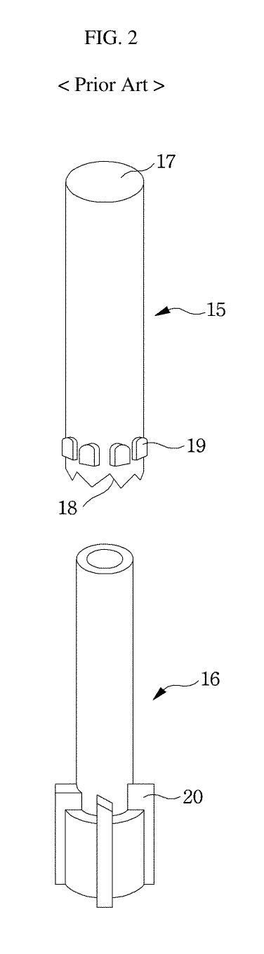

(a) in FIG. 3 is a diagram showing a shirt stained with ink due to ink leaks in the event that a button section of a knock type pen is pressed when a user puts the knock type pen on the shirt's pocket, and (b) is an enlarged view of the contaminated part in (a).

FIG. 4 is a diagram showing a bag stained with ink due to ink leaks in the event that a button section of a knock type pen is pressed when a user puts the knock type pen in the bag.

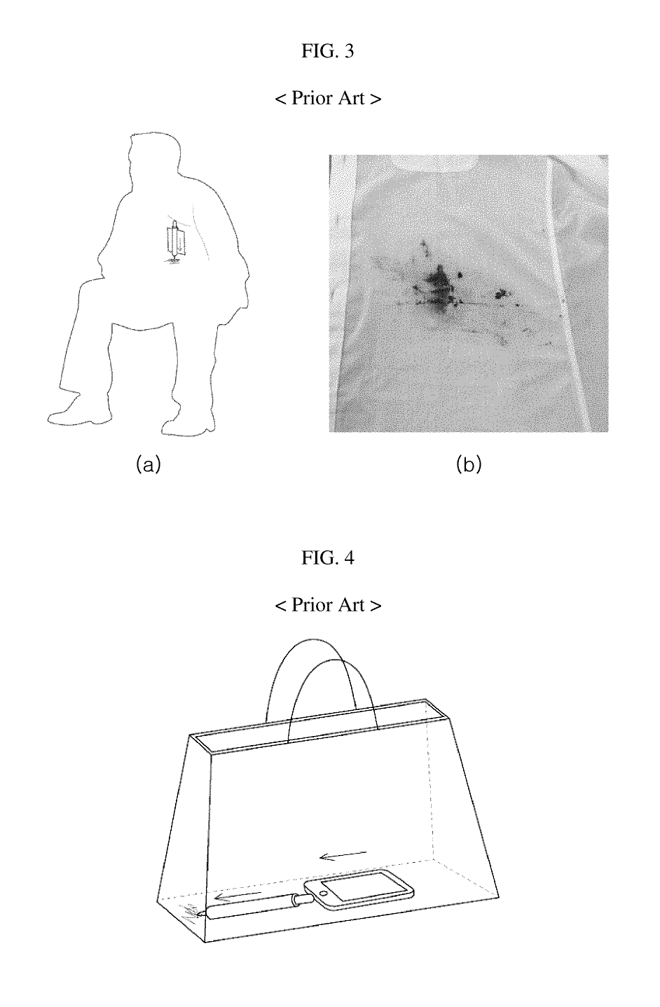

FIG. 5 is a diagram of a knock type pen according to the present disclosure showing that a nib is pushed out of a housing when a button section of a knock element is pressed.

FIG. 6 is a diagram of a knock type pen according to the present disclosure showing that a stopper protrusion formed in a knock element is inserted into a stopper hole formed in a housing.

FIG. 7 is an exploded view of a knock element, an upper housing, a toothed protrusion, a rotary cam, a lead and a lower housing of a knock type pen according to the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

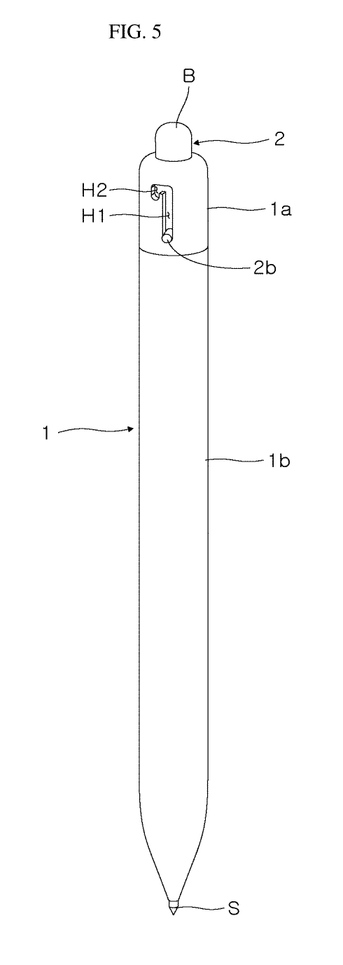

FIGS. 5 to 7 are diagrams showing a knock type pen according to the present disclosure.

The knock type pen according to the present disclosure includes a housing 1, a knock element 2, and a rotary cam 3 as shown in FIGS. 5 to 7.

The housing 1 is in hollow shape in which a lead C storing ink is received.

The lead C is installed moveably up and down in the housing 1, and the lead C is subjected to an elastic force by a spring installed in the housing 1 in a direction in which a nib S at the end retracts into the housing 1.

Furthermore, as shown in FIG. 5, the housing 1 has a guide hole H1 formed therethrough along the lengthwise direction of the housing 1, and when the knock element 2 as described below moves up, the knock element 2 is guided as a stopper protrusion 2b protrusively formed on the outer circumferential surface of the knock element 2 is inserted into the guide hole H1.

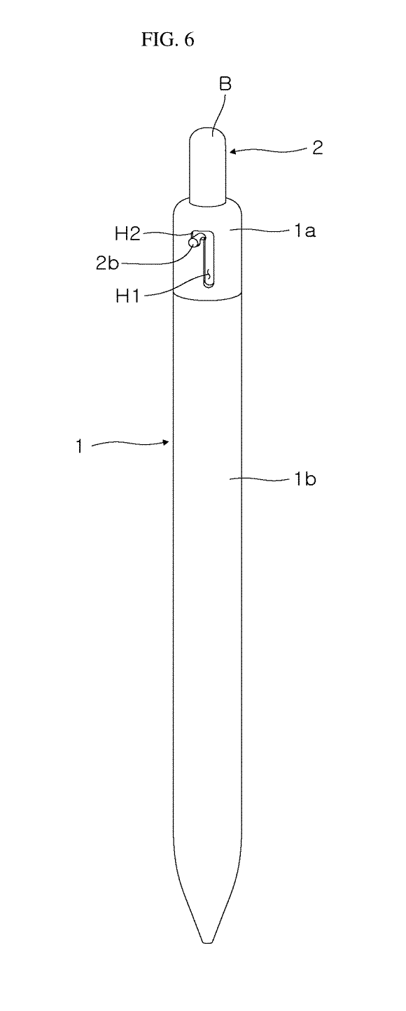

Moreover, as shown in FIGS. 5 and 6, a stopper hole H2 is formed therethrough extending in parallel or at a downward slant in the outer circumferential direction of the housing 1 from the upper end of the guide hole H1 formed in the housing 1, to limit the upward movement of the knock element 2 with the stopper protrusion 2b inserted into the stopper hole H2.

Accordingly, it can prevent ink from leaking through the nib S extended outside by a user's unintentional knock pressing and leaving stains on clothes or a bag.

As above, the guide hole H1 and the stopper hole H2 formed in the housing 1 is in elliptical shape to conform to the stopper protrusion 2b protrusively formed on the outer circumferential surface of the knock element 2.

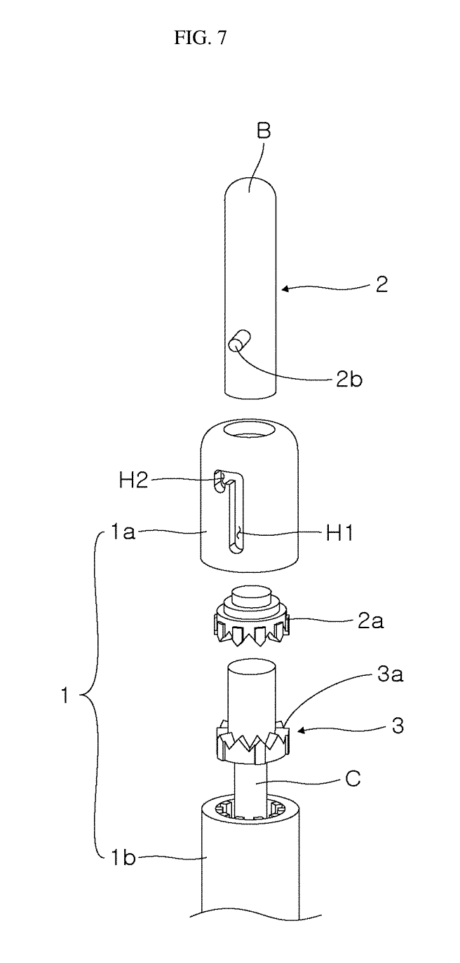

Meanwhile, as shown in FIG. 7, the housing 1 may include an upper housing 1a having the guide hole H1 and the stopper hole H2 to move the knock element 2 up and down, and a lower housing 1b in which the lead C and the rotary cam 3 are received, and in this instance, the upper housing 1a and the lower housing 1b are formed attachably and detachably.

For example, the attachable and detachable configuration of the upper housing 1a and the lower housing 1b may be implemented by a screw coupling method, a fitting method, and a variety of other methods.

As above, when the housing 1 is divided into the upper housing 1a and the lower housing 1b which are coupled attachably and detachably, an advantage is that it is convenient in replacing internal components and maintaining and repairing them.

The knock element 2 is placed moveably up and down in the housing 1, and as shown in FIG. 7, a button section B protruding from the open upper side of the upper housing 1a is formed in the upper end part, and a toothed protrusion 2a is coupled to the lower end part and comes into contact with a guide protrusion 3a formed in the rotary cam 3 as described below.

The stopper protrusion 2b is protrusively formed on the outer circumferential surface of the knock element 2 in a direction perpendicular to the lengthwise direction of the knock element 2, and the stopper protrusion 2b is preferably in cylindrical shape.

In this instance, the protruding end of the stopper protrusion 2b is exposed to the outside of the guide hole H1 and the stopper hole H2 formed in the housing 1, allowing the user to easily manipulate the knock element 2.

The rotary cam 3 is disposed between the lead C and the knock element 2 and rotatably placed in the housing 1, and the rotary cam 3 has the guide protrusion 3a that comes into contact with the toothed protrusion 2a coupled to the lower end part of the knock element 2.

The configuration that when the user presses the button section B of the knock element 2, the toothed protrusion 2a of the knock element 2 and the guide protrusion 3a of the rotary cam 3 are bought into contact to push the nib S out of the housing 1 is described in detail in the background part of the specification, and its description is omitted herein.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A knock type pen comprising:
a housing in which a lead storing ink is received;
a knock element which is placed moveably up and down in the housing, and has a button section protruding from an open upper side of the housing in an upper end part and a toothed protrusion coupled to a lower end part; and
a rotary cam which is disposed between the lead and the knock element and rotatably placed in the housing, and has a guide protrusion which comes into contact with the toothed protrusion,
wherein a stopper protrusion is protrusively formed in a direction perpendicular to a lengthwise direction of the knock element on an outer circumferential surface of the knock element,
wherein the housing has a guide hole formed therethrough along a lengthwise direction of the housing to guide the knock element with the stopper protrusion inserted into the guide hole when the knock element moves up,
wherein a stopper hole formed therethrough extending in parallel or at a downward slant in an outer circumferential direction of the housing from an upper end of the guide hole to limit an upward movement of the knock element with the stopper protrusion inserted into the stopper hole.

2. The knock type pen of claim 1, wherein the stopper protrusion is in cylindrical shape, the guide hole and the stopper hole are in elliptical shape to conform to the stopper protrusion, and a protruding end of the stopper protrusion is exposed to outside of the guide hole and the stopper hole.

3. The knock type pen of claim 1,
wherein the housing comprises an upper housing having the guide hole and the stopper hole to move the knock element up and down, and a lower housing in which the lead and the rotary cam are received,
wherein the upper housing and the lower housing are formed attachably and detachably.
